(19) United States
(12) Patent Application Publication
(10) Pub. No.: US 2022/0147678 A1
(43) Pub. Date: May 12, 2022

(54) SYSTEMS AND METHODS FOR CAPACITANCE EXTRACTION

(71) Applicant: Taiwan Semiconductor Manufacturing Company, Ltd., Hsinchu (TW)

(72) Inventors: Kuo Fu LEE, Zhudong Township (TW); Ching Yang YEN, Miaoli City (TW); Ke-Ying SU, Taipei City (TW); Chau-Wen WEI, Hsinchu City (TW)

(73) Assignee: Taiwan Semiconductor Manufacturing Company, Ltd., Hsinchu (TW)

(21) Appl. No.: 17/363,298

(22) Filed: Jun. 30, 2021

Related U.S. Application Data
(60) Provisional application No. 63/111,785, filed on Nov. 10, 2020.

(51) Int. Cl. G06F 30/367; G06F 30/392; G06F 30/323; G06F 30/31

(52) U.S. Cl. CPC G06F 30/367; G06F 30/31; G06F 30/323; G06F 30/392

(57) ABSTRACT

A method for capacitance extraction includes: performing a first capacitance extraction on one or more first regions of a semiconductor layout; performing a second capacitance extraction on one or more second regions of the semiconductor layout, a resolution of the second capacitance extraction being less than a resolution of the first capacitance extraction; constructing a netlist for the semiconductor layout based on results of the first capacitance extraction and of the second capacitance extraction; and modifying the semiconductor layout based on the netlist. The modified semiconductor layout is used to fabricate an integrated circuit.

### REFERENCE TO RELATED APPLICATION

This application claims the benefit of U.S. Provisional Application No. 63/111,785, filed on Nov. 10, 2020, entitled “METHOD FOR ESTIMATING CHARACTERISTICS OF A SEMICONDUCTOR DEVICE,” the entirety of which is incorporated by reference herein.

### BACKGROUND

Different design methods and Electronic Design Automation (“EDA”) tools are arranged to design Integrated circuits (“ICs”) of various levels of complexity. IC design engineers design an integrated circuit by transforming a circuit specification into geometric descriptions of physical components that in combination form basic electronic components. In general, the geometric descriptions are polygons of various dimensions, representing conductive features located in different processing layers. The geometric descriptions of physical components are generally referred to as integrated circuit layouts. After the creation of an initial integrated circuit layout, the integrated circuit layout is usually tested and optimized through a set of steps in order to verify that the integrated circuit meets the design specification with the parasitic capacitances and resistances in the IC. The integrated circuit layout can be changed through one or more design optimization cycles until the simulation results satisfy the design specification.

The parasitic capacitances and resistances can cause various detrimental effects and undesirable performance in a designed IC, such as undesired long signal delays on various interconnects. Thus, the impact of the parasitic capacitances and resistances on the performance of the designed IC must be accurately predicted so that design engineers can compensate for these detrimental effects through proper design optimization steps.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a design system, in accordance with some embodiments of the present disclosure.

FIG. 2 is a flowchart illustrating a simplified IC design process, in accordance with exemplary embodiments of the present disclosure.

FIG. 3 is a schematic diagram of a semiconductor layout in accordance with exemplary embodiments of the present disclosure.

FIG. 4 is a schematic diagram of a semiconductor layout partitioned into regions in accordance with exemplary embodiments of the present disclosure.

FIG. 5A and FIG. 5B are schematic diagrams illustrating 3D capacitance determination processes applying different step size parameters, in accordance with exemplary embodiments of the present disclosure.

FIG. 6 is a schematic diagram of a semiconductor layout partitioned into regions in accordance with exemplary embodiments of the present disclosure.

FIG. 7 is a schematic diagram of a semiconductor layout partitioned into regions in accordance with exemplary embodiments of the present disclosure.

FIG. 8 is a schematic diagram of a semiconductor layout in accordance with exemplary embodiments of the present disclosure.

FIG. 9 is a flow chart illustrating a method for capacitance extraction in accordance with exemplary embodiments of the present disclosure.

FIG. 10 is an exemplary netlist constructed after the capacitance extractions in accordance with exemplary embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In this document, the term “coupled” may also be termed as “electrically coupled”, and the term “connected” may be termed as “electrically connected.” “Coupled” and “connected” may also be used to indicate that two or more elements cooperate or interact with each other.

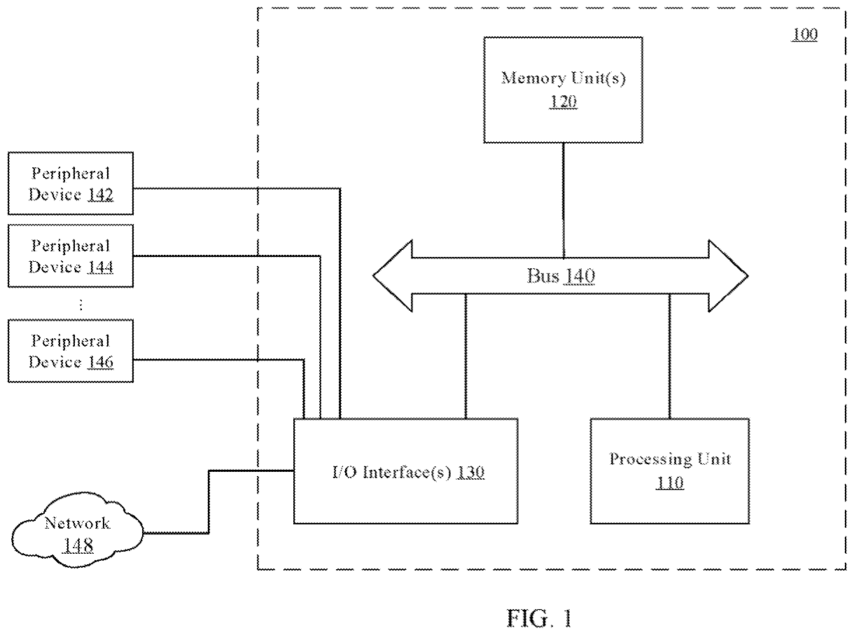

FIG. 1 is a schematic diagram of a design system 100, in accordance with some embodiments of the present disclosure. As illustratively shown in FIG. 1, the design system 100 includes a processing unit 110, one or more memory units 120, an Input/output (I/O) interfaces 130, and a bus 140. In some embodiments, the processing unit 110 is communicatively coupled to the memory unit(s) 120 and the I/O interfaces 130 via the bus 140. In various embodiments, the processing unit 110 can be a central processing unit (CPU), an application specific integrated circuit (ASIC), a multi-processor, a distributed processing system, or a suitable processor. Various circuits or units to implement the processing unit 110 are within the contemplated scope of the present disclosure.

The memory unit(s) 120 stores one or more program codes for aiding design of integrating circuits. For example, the memory unit(s) 120 can store instructions for one or more programs executable by the processing unit to perform operations. For illustration, the memory unit(s) 120 stores program codes encoded with a set of instructions for performing capacitance extraction of a layout or layout patterns of integrating circuits. In some embodiments, when the processing unit 110 executes the program codes, and the operations of capacitance extraction are able to be automatically performed. Accordingly, by the processing unit 110 and the program codes stored in the memory unit(s) 120, electronic design automation (EDA) tools can run on the design system 100 to assist IC designers in various steps in the IC design process.

In some embodiments, the memory unit(s) 120 can be a non-transitory computer readable storage medium encoded with, e.g., storing, a set of executable instructions for performing capacitance extraction. In some embodiments, the computer readable storage medium is an electronic, magnetic, optical, electromagnetic, infrared, and/or a semiconductor system (or apparatus or device). For example, the computer readable storage medium includes a semiconductor or solid-state memory, a magnetic tape, a removable computer diskette, a random-access memory (RAM), a read-only memory (ROM), a rigid magnetic disk, and/or an optical disk. In one or more embodiments using optical disks, the computer readable storage medium includes a compact disk-read only memory (CD-ROM), a compact disk-read/write (CD-R/W), a digital video disc (DVD), a flash memory, and/or other media, now known or later developed, that are capable of storing code or data. Hardware modules or apparatuses described in this disclosure include, but are not limited to, application-specific integrated circuits (ASICs), field-programmable gate arrays (FPGAs), dedicated or shared processors, and/or other hardware modules or apparatuses now known or later developed.

The I/O interfaces 130 are configured to receive inputs or commands from various control devices which, for example, are operated by a circuit designer and/or a layout designer. Accordingly, the design system 100 can be controlled with the inputs or commands received by the I/O interfaces 130. In some embodiments, the I/O interfaces 130 can be communicatively coupled to one or more peripheral devices 142, 144, 146, which can be storage devices, servers, displays (e.g., cathode ray tube (CRT), liquid crystal display (LCD), touch screen, etc.) configured to display the status of the program code execution, or input devices (e.g., keyboard, keypad, mouse, trackball, trackpad, touch screen, cursor direction keys, or the combination thereof) for communicating information and commands to the processing unit 110. The design system 100 can also transmit data to or communicate with peripheral device(s) or other terminal devices through a network 148, such as a local network, an internet service provider, internet, or any combination thereof.

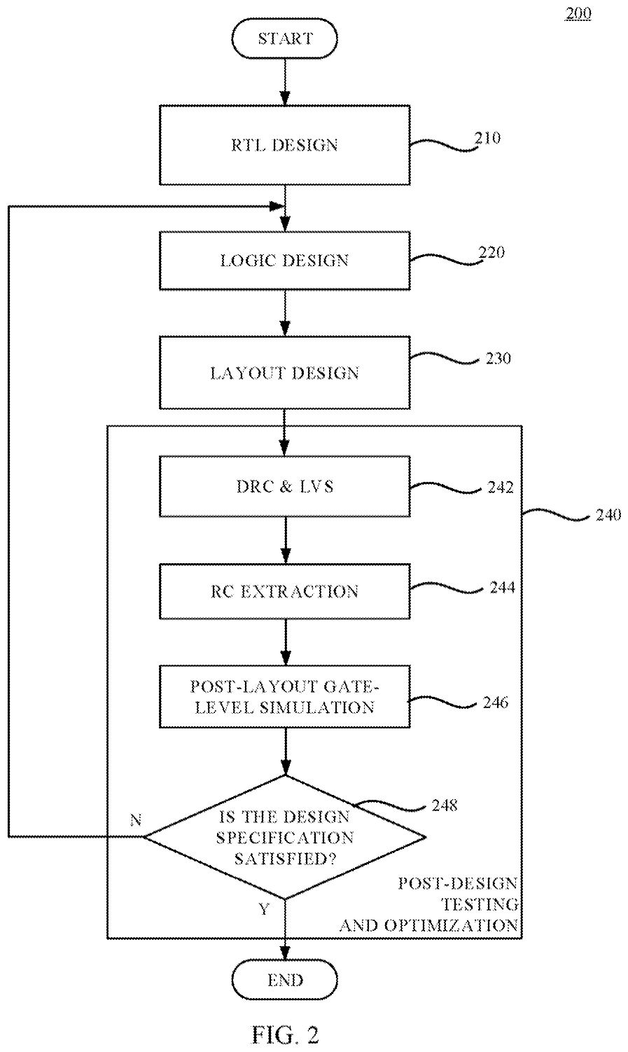

FIG. 2 is a flowchart illustrating a simplified IC design process 200, in accordance with certain embodiments of the present disclosure. As shown in FIG. 2, at a register transfer level (RTL) design phase 210, system specifications, such as desired function, communication, and other requirements, are transformed into an RTL design. The RTL design may be a design abstraction which models a synchronous digital circuit in terms of the flow of digital signals (data) between hardware registers, and the logical operations performed on those signals. The RTL design may be provided in the form of a programming language, such as VHDL or Verilog and typically describes the behavior of the digital circuits, as well as the interconnections to inputs and outputs. The RTL design may be provided for a System-on-Chip (SoC), a block, cell, and/or components of an SoC, one or more sub-blocks, cells, or components of a hierarchical design.

At a logic design phase 220, the RTL design is converted into a logic design resulting in a netlist of connected logic circuits. The logic design may employ typical logic components, such as AND, OR, XOR, NAND, and NOR components as well as cells exhibiting a desired functionality from one or more libraries. In some instances, one or more intellectual property (IP) cores may be utilized and embedded within the SoC. Accordingly, a netlist describing the connectivity of the various electronic components of the circuits involved in connection with the design may be generated. For example, a netlist may include a list of the electronic components in the circuit and a list of the nodes they are connected to. In some embodiments, design constraints and the RTL design are sent to a synthesizer for Logic Synthesis to generate a pre-layout gate-level netlist. Then, the pre-layout gate-level netlist can be integrated into a verification environment for system gate-level simulation. After the simulation and verification, the logic design is completed.

At a layout design phase 230, gate level netlists are converted to a physical geometric representation. For example, the layout design phase 230 may include a floor-planning, which is a process of placing various blocks, cells, and/or components, and input/output pads across an area based on the design constraints. Such resources may be arranged on one or more layers of the device. Placement blockages may be created at the floor planning stage resulting in routing blockages function as guidelines for placement of standard cells. As one example, a SoC design may be partitioned into one or more functional blocks, or partitions. Then, a Placement & Route tool (P&R) may perform the placement of physical elements within each block and integration of analog blocks or external IP cores, and run a routing to connect the elements together. Accordingly, an initial integrated circuit layout is created.

At a post-design testing and optimization phase 240, steps 242, 244, 246, and 248 are performed. Particularly, a Design-Rule Check (DRC) and Layout Versus Schematic (LVS) step 242 can be performed to check whether the created layout against design rules and verify whether the created layout is equivalent to the desired design schematic. Then, a resistance and capacitance extraction (RC extraction) step 244 can be performed in order to “extract” electrical characteristics of the layout. The common electrical characteristics that are extracted from an integrated circuit layout include capacitances and resistances in the electronic devices and the various interconnects (also generally referred to as “nets”) that electrically connect the aforementioned devices. This step can also be referred to as “parasitic extraction” because these capacitance and resistance values are generally properties of the underlying device physics of the device configurations and materials used to fabricate the IC and not put into place by the IC designer.

Then, a post-layout gate-level simulation step 246 can be performed on the designed IC to ensure the design meets the specification with the parasitic capacitances and resistances in the IC. If the parasitic capacitances and resistances cause undesirable performance (step 248—No), the integrated circuit layout can be changed through one or more design optimization cycles by repeating the logic design phase 220, the layout design phase 230, and the post-design testing and optimization phase 240 until the simulation results satisfy the design specification (step 248—Yes).

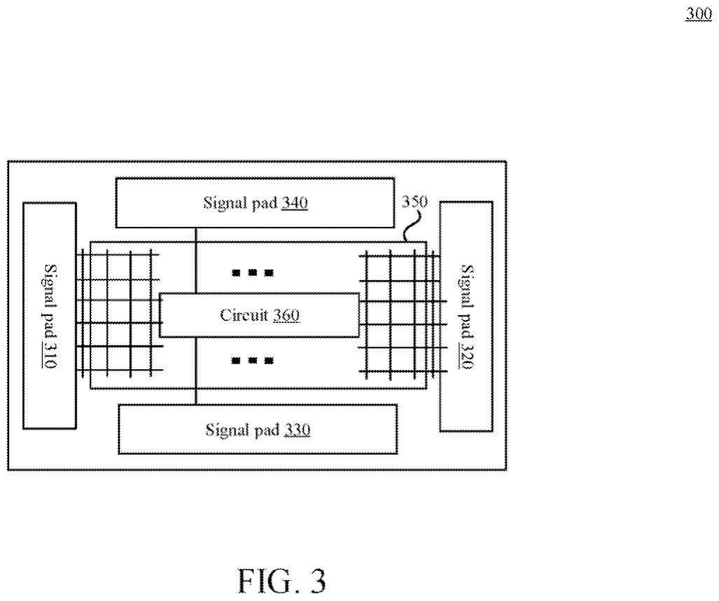

FIG. 3 is a schematic diagram of a semiconductor layout 300, for explaining exemplary parasitic capacitance extraction processes in accordance with certain embodiments of the present disclosure. As shown in FIG. 3, in some embodiments, the semiconductor layout 300 includes signal pads 310, 320, 330 and 340, and a mesh network 350. For example, signal pad 310 may include a VDD network coupled to a first power supply source configured to provide a first supply voltage that is commonly a positive supply voltage (e.g., VDD). Signal pad 320 may include a VSS network coupled to a second power supply source configured to provide a second supply voltage that is commonly a negative supply voltage or ground (e.g., VSS). Signal pad 330 may include an enable network for EN signals, and signal pad 340 may be an output network for output signals. In some embodiments, mesh network 350 can be a power distribution network (PDN) mesh network with dummy devices and one or more circuits coupled between the signal pads 310, 320, 330 and 340. For example, mesh network 350 may include a target circuit (e.g. a functional circuit 360), such as a 101-stages ring oscillator, SRAM bit cell (BC) array, etc.

When performing RC extraction on the semiconductor layout 300, the design system 100 can run the program to recognize one or more patterns (e.g., “primitive patterns”) of one or more electrical components in the semiconductor layout 300 and extract parasitic parameters from the recognized patterns. Among these parasitic parameters, the parasitic capacitance influences time delay, power consumption, and the signal integrity. EDA tools running on the design system 100 can provide various capacitance extraction tools to forecast a power, performance, and area (PPA) estimation based on the parasitic parameters, so that foundries can improve the designs to meet the PPA targets defined by foundry and customers in advanced nodes. For example, capacitance extraction tools may include one or more capacitance extractors applying a 2-dimensional (2D) RC extraction methodology, a 2.5-dimensional (2.5-D) RC extraction methodology, a 3-dimensional (3D) RC extraction methodology, or any other proper RC extraction methodologies.

In general, the 2.5-D RC extraction methodology is more accurate than a 2-dimensional (2D) RC extraction methodology and less accurate than a 3D RC extraction methodology. On the other hand, the 2.5-D RC extraction methodology requires more extraction time compared to a 2D RC extraction methodology, and less extraction time compared to a 3D RC extraction methodology due to the complexity of the estimation and calculation.

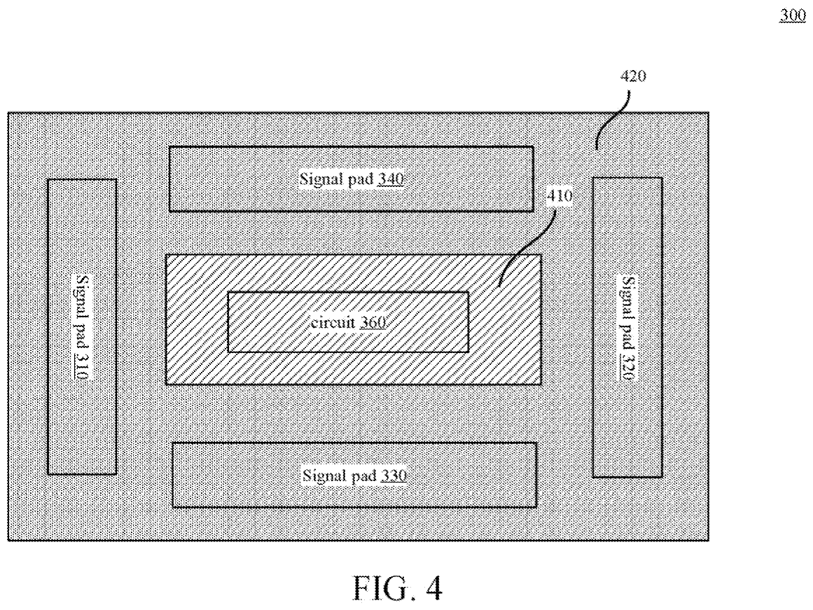

In some embodiments of the present disclosure, EDA tools may apply different accuracies for capacitance extractions in different regions in the semiconductor layout 300. Reference is made to FIG. 4, which is a schematic diagram of the semiconductor layout 300 partitioned into regions 410 and 420, for explaining parasitic capacitance extraction processes in accordance with some embodiments of the present disclosure. In some embodiments, at least one of the regions 410 and 420 may be a 3D region having a Z boundary in the thickness direction (Z direction) of the semiconductor layout 300. The regions 410 and 420 also have boundaries in the X-Y plane, e.g., X boundaries in the X direction and Y boundaries in the Y direction. The boundaries can be specified by a user and/or automatically generated by the design system 100. In some embodiments, the region 410 is not necessarily rectangular shaped as illustrated in FIG. 4.

In some embodiments, the user specifies the X and the Y boundaries in the semiconductor layout 300. The user may also specify the Z boundary by identifying the number of layers that are to be included in the region 410. In some embodiments, the Z boundary includes all layers of the semiconductor layout 300, while in some other embodiments, the Z boundary includes some but not all of the layers of the semiconductor layout 300.

A more accurate RC extraction result can reduce the gap between simulation and silicon measurements and assist IC designers in optimizing the semiconductor layout, but it costs more computational resources and is also time consuming. Under practical time and/or computational resource restraints, it would be difficult for the design system 100 to achieve both the high accuracy and the high efficiency for all components during the RC extraction. The user or the design system 100 has to choose to prioritize one over the other based on several factors, such as the complexity of the circuit, to optimize the overall RC extraction accuracy and efficiency. In some embodiments, the design system 100 can execute the program to automatically recognize the region 410 as a region where RC extraction accuracy is preferred over efficiency, and automatically identify the boundaries of the region 410. For example, an LVS extraction tool can be used to recognize various circuits or electrical components, e.g., transistors, conductors, etc., in the semiconductor layout 300. In some embodiments, the design system 100 may assign a higher accuracy setting for transistors with complex 3D structure, and a lower accuracy setting for conductors. The LVS extraction tool therefore automatically identifies locations of those electrical components. Then, an RC extraction tool can automatically generate the boundaries of the region 410 from pre-defined rules based on the location information of the electrical components. In some embodiments, the types of electrical components or circuits of the semiconductor layout 300 subjected to a higher accuracy setting are preset in the RC extraction tool.

In some embodiments, the region 410 can be identified partially by user-defined settings and partially by the design system 100. For example, the user may identify the Z boundary, and the design system 100 may automatically identify the X boundary and Y boundary of the region 410. In another example, the user may specify an area (in any one or more of the X, Y and Z directions) where RC extraction accuracy is preferred over efficiency, and the design system 100 may automatically identify one or more regions 410 from the user-specified area.

As shown in FIG. 4, the region 420 may be an area including signal pads 310, 320, 330 and 340, while the region 410 may be an area including one or more functional circuits 360 (e.g., 101-stages ring oscillator, SRAM BC array, etc.). In certain embodiments, the functional circuits 360 may be the critical circuit(s) where a higher RC extraction accuracy is preferred. In order to provide an overall optimum extraction accuracy for regions 410 and 420 given the computing resources or time constraints, the design system 100 may automatically choose to run the program to apply different configurations in the regions 410 and 420 to provide different accuracy to capacitance extractions, without costing a significant amount of machine resources or significant turn-around time for the capacitance extractions. For example, in some embodiments, the design system 100 can perform a first capacitance extraction on the region 410 with a first resolution (e.g., accuracy with a tolerance of about 0.3%), and perform a second capacitance extraction on the region 420 with a second resolution (e.g., accuracy with a tolerance of about 3%) that is lower than the first resolution. Accordingly, a relatively high accuracy setting, with a high time and resource demand, can be applied to the critical functional circuit(s) (e.g., the circuit(s) 360) of the semiconductor layout 300, while a relatively low accuracy setting, with low time and resource demand, can be applied for extracting parasitic parameters outside the region 420, where speed and efficiency are preferred over the accuracy, to reduce the overall time and computing resources for the capacitance extraction. Thus, in some embodiments, the capacitance extractions for the overall layout design can be done without the stitching process required in mesh and parallel simulation methods, and issues or risks induced by the stitching process can be avoided. As a result, it is possible to achieve a fast and accurate parasitic parameters extraction result.

For example, in some embodiments, the design system 100 can apply different step size parameter parameters to regions 410 and 420 when applying the 3D capacitance determination process. Alternatively stated, the design system 100 can apply the 3D capacitance determination process based on a first step size parameter to generate a first netlist including one or more capacitance results associated with the region 420, while applying the 3D capacitance determination process based on a second step size parameter greater than the first step size parameter to generate a second netlist comprising one or more capacitance results associated with the one or more second regions.

In some embodiments, the first step size parameter or the second step size parameter associated with different accuracy settings can be preset and prestored in a database in the design system 100. In some embodiments, the IC designer can also manually configure the one or more step size parameters for the first capacitance extraction or the second capacitance extraction via the I/O interfaces 130 of the design system 100. In some embodiments, the design system 100 can also run the program to determine one or more step size parameters for the first capacitance extraction or the second capacitance extraction by an artificial intelligence (AI) or machine learning (ML) model.

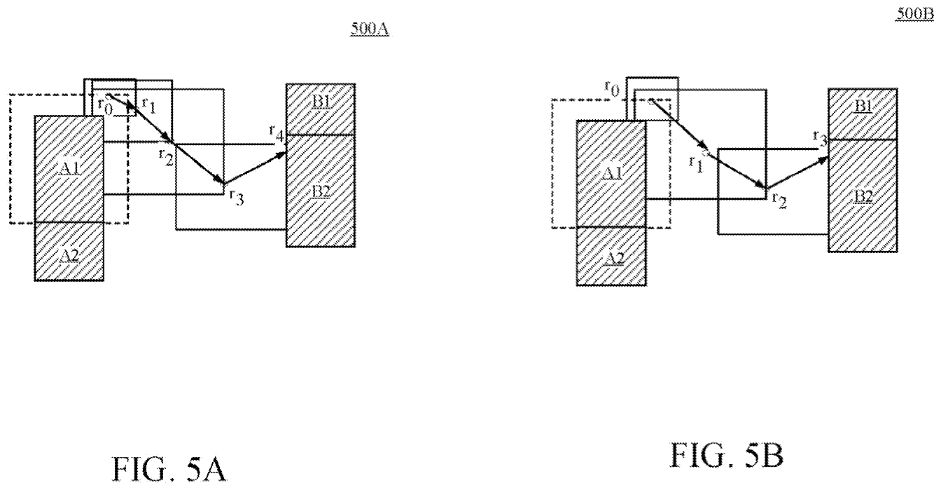

FIG. 5A and FIG. 5B are schematic diagrams illustrating 3D capacitance determination processes applying different step size parameters, in accordance with some embodiments of the present disclosure. As shown in FIG. 5A and FIG. 5B, layouts 500A and 500B both include structures A and B, which are respectively partitioned into portions A1 and A2, and B1 and B2.

3D field solvers (3DFS) are 3D RC extraction tools to perform 3D field solve simulations. The simulations use Maxwell's equations to calculate electromagnetic fields, and the electromagnetic fields to calculate the corresponding electrical parameters such as parasitic capacitance, resistance, and/or inductance. In some embodiments, random walk technologies can be applied in a 3D field solver to solve the equations in 3D and can be used to compute capacitances between any pair of interconnects in a layout with high accuracies. By applying the random walk method for extracting layout parasitic capacitances, the 3D field solvers allow users to specify accuracy bounds and calculate the results at user-specified accuracies. For example, different accuracy settings may be associate with different step size parameters (e.g., the maximum step size for the random walk).

For example, the capacitance value C_{A1B2} between portions A1 and B2 illustrated in FIG. 5A and FIG. 5B may be calculated and obtained using following equations:

C_{A1B2}=Q_{A}/V_{B}

Q_{A}=∫∫εE(rₖ)dSₖ

E(rₖ)=∫∫G_{E}(rₖ−rₖ₋₁)V(rₖ)dSₖ

V(rₖ)=∫∫G_{V}(rₖ₊₁−rₖ)Vₖ₊₁dSₖ₊₁,

where V_{B} denotes the given boundary condition, Q_{A} denotes the charge to be calculated by the random walk including a succession of random steps, rₖ denotes the kth step size of the random walk, Sₖ denotes the area (e.g., a Gaussian integration surface) of the rectangle associated with the kth random step of the random walk, G_{E} and G_{V} denote the Green's functions, and ε denotes the dielectric parameter between portions A1 and B2.

As shown in FIG. 5A, when the 3D capacitance determination process is performed based on a relatively small step size parameter (e.g., in the region 410 of FIG. 4), the number of the steps of the random walk is greater and results in a higher resolution. On the other hand, as shown in FIG. 5B, when the 3D capacitance determination process is performed based on a relatively large step size parameter (e.g., in the region 420 of FIG. 4), the random selection of the step size in the random walk is “unwind,” e.g., is extended to a range with larger possible values, and results in less steps and lower resolution, which accelerates the extraction.

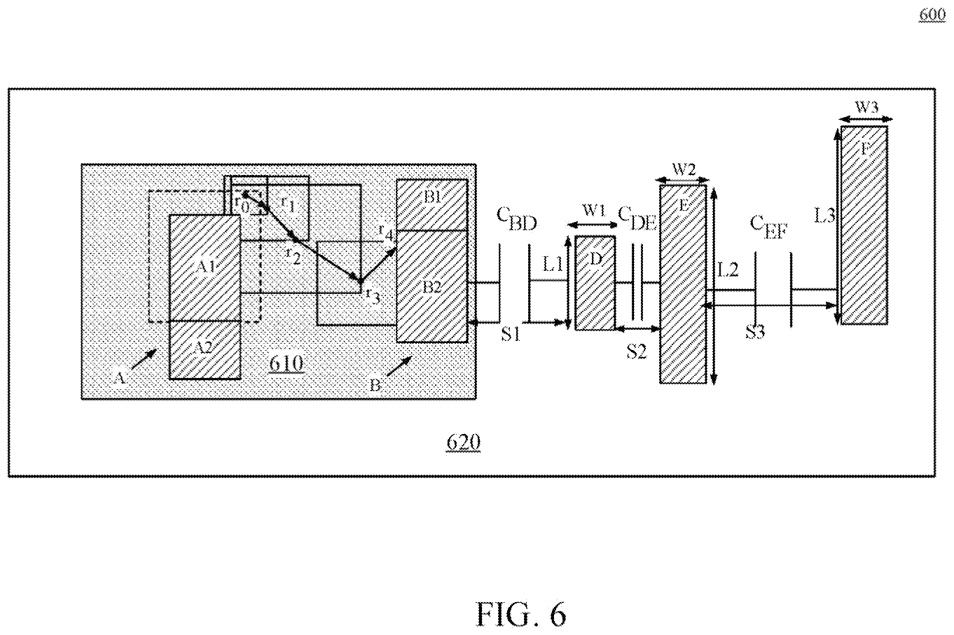

Reference is made to FIG. 6, which is a schematic diagram of the semiconductor layout 600 partitioned into regions 610 and 620, for explaining exemplary parasitic capacitance extraction processes in accordance with some embodiments of the present disclosure. As shown in FIG. 6, the semiconductor layout 600 includes structures A, B, D, E, and F, in which structures A, B are respectively partitioned into portions A1 and A2, and B1 and B2.

As shown in FIG. 6, in some embodiments, the design system 100 can apply different types of capacitance determination processes to regions 610 and 620 to quickly achieve an accurate parasitic parameters extraction result. Alternatively stated, the design system 100 can perform a “hybrid” extraction combining two or more different capacitance extraction tools or processes. For example, the design system 100 can apply a 3D capacitance determination process based on a selected step size parameter to generate a first netlist including one or more capacitance results associated with the region 610, while applying a 2.5-D capacitance determination process to generate a second netlist comprising one or more capacitance results associated with the region 620. As another example, the design system 100 may select any two of the 3D, 2.5-D, 2D, or 1D capacitance determination processes to be applied to regions 610 and 620 respectively. Other combinations and permutations of different types of capacitance determination processes may be used.

In some embodiments, in the area outside of the region 610, a 2.5-D capacitance determination process may be performed by a rule-based capacitance extractor to quickly and efficiently calculate the capacitance values. For example, the capacitance values C_{BD}, C_{DE}, C_{EF} can be respectively calculated based on corresponding unit capacitance values and the length values of structures D, E, and F. The unit capacitance values may depend on different metal width values and space combinations and be obtained based on the predefined rules by the 2.5-D capacitance extractor. For example, the capacitance value C_{BD} between structures B and D, as shown in FIG. 6, can be calculated and obtained using following equation:

C_{BD}=UnitCap1×L1,

where UnitCap1 denotes a corresponding unit capacitance value obtained based on the metal width W1 of the structure D and space combination S1 between structures B and D, and L1 denotes the length of the structure D. Similarly, the capacitance values C_{DE} and C_{EF} respectively between the structures D and E and between structures E and F can be calculated and obtained using similar equations:

C_{DE}=UnitCap2×L2

C_{EF}=UnitCap3×L3,

where UnitCap2 denotes a corresponding unit capacitance value obtained based on the metal width W2 of the structure E and space combination S2 between structures D and E, UnitCap3 denotes a corresponding unit capacitance value obtained based on the metal width W3 of the structure F and space combination S3 between structures E and F, L2 denotes the length of the structure E, and L3 denotes the length of the structure F.

On the other hand, in the area within the region 610, a 3D capacitance determination process, as described herein, may be performed based on a selected step size parameter.

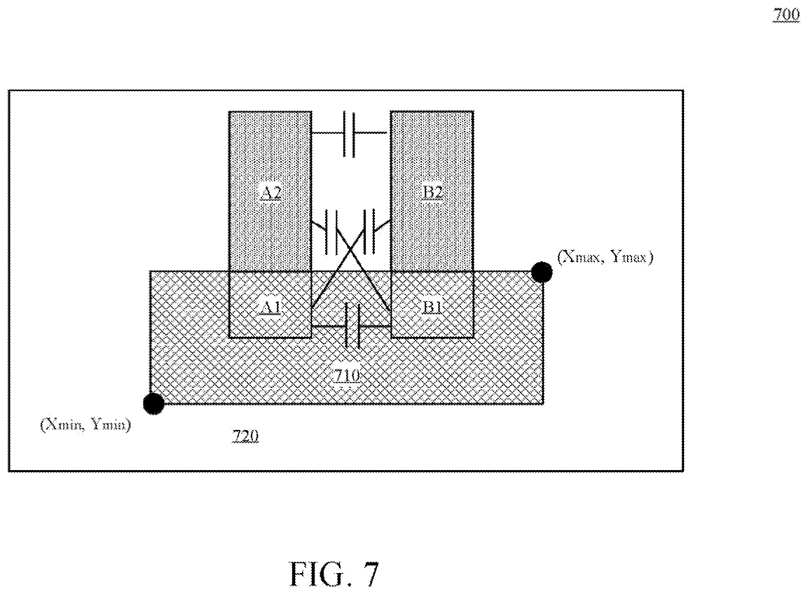

Reference is made to FIG. 7, which is a schematic diagram of a semiconductor layout 700 partitioned into regions 710 and 720, for explaining exemplary parasitic capacitance extraction processes in accordance with some embodiments of the present disclosure. As shown in FIG. 7, in some embodiments, a net may cross the region 710 with a high accuracy setting and the region 720 with a low accuracy setting. Alternatively stated, one or more electrical components (e.g., structures A and B) may be partially inside the region 710 (e.g., portion A1 of the structure A and portion B1 of the structure B) and partially outside the region 710 and within the region 720 (e.g., portion A2 of the structure A and portion B2 of the structure B). As shown in FIG. 7, the X and Y boundaries of the region 710 can be defined by a minimum X coordinate Xₘᵢₙ, a minimum Y coordinate Yₘᵢₙ, a maximum X coordinate Xₘₐₓ, and a maximum Y coordinate Yₘₐₓ.

In some embodiments, the design system 100 can apply a first accuracy setting (e.g., a high accuracy setting) for parasitic capacitance between portion A1 and portion B1, which are both located within the region 710, and apply a second accuracy setting (e.g., a low accuracy setting) for parasitic capacitances between portion A1 and portion B2, between portion A2 and portion B1, and between portion A2 and portion B2, of which at least one of the portions are within the region 720.

For example, if the 3D capacitance extractor is applied to both regions 710 and 720, the design system 100 may run the program to calculate, based on a first step size parameter, a first capacitance parameter C_{A1B1} associated with the portion A1 and the portion B1 within the region 710. In addition, the design system 100 may run the program to calculate, based on a second step size being different from the first step size, a second capacitance parameter C_{A2B2} associated with the portion A2 and the portion B2 within the region 720, a third capacitance parameter C_{A1B2} associated with the portion A1 and the portion B2, and a fourth capacitance parameter C_{A2B1} associated with the portion A2 and the portion B1.

Then, the 3D capacitance extractor can calculate a total capacitance value C_{AB} associated with the structure A and the structure B based on the first capacitance parameter C_{A1B1}, the second capacitance parameter C_{A2B2}, the third capacitance parameter C_{A1B2}, and the fourth capacitance parameter C_{A2B1} by the following equation:

C_{AB}=C_{A1B1}+C_{A1B2}+C_{A2B1}+C_{A2B2}

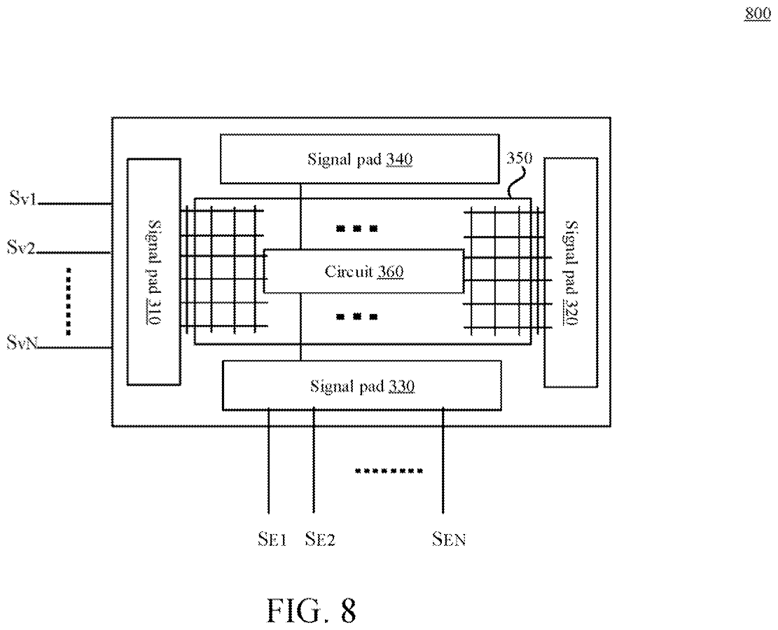

Reference is made to FIG. 8, which is a schematic diagram of a semiconductor layout 800, for explaining exemplary parasitic capacitance extraction processes in accordance with some embodiments of the present disclosure. Similar to the semiconductor layout 300 of FIG. 3, the semiconductor layout 800 of FIG. 8 also includes signal pads 310, 320, 330 and 340, and the mesh network 350. As shown in FIG. 8, signal pad 310, which includes a VDD network, is configured to receive voltage signals S_{V1}, S_{V2}-S_{VN}, and the signal pad 330, which includes an enable network, is configured to receive enable signals S_{E1}, S_{E2}-S_{EN}. In some embodiments, different accuracy settings can be applied to different regions or areas corresponding to the different signals identified or selected by the user or by the design system 100. For example, the user can pre-define specific signals of the semiconductor layout 800. Accordingly, when performing the capacitance extractions, the design system 100 can determine a corresponding accuracy configuration associated with the one or more signals of the semiconductor layout 800, and then apply the capacitance determination process based on the accuracy configuration to calculate the capacitance value between at least two components associated with the signal.

By various methods described above, results of the capacitance extractions using different accuracy settings can be obtained. It is noted that, while one target region (e.g., the region 410, 610 or 710) associated with a high accuracy configuration is determined in the exemplary embodiments of FIG. 4, FIG. 6, or FIG. 7, the present disclosure is not limited thereto. In some embodiments, the design system 100 may identify two or more target regions in the layout, and apply the same high accuracy setting for these target regions when performing the capacitance extractions. In some other embodiments, the design system 100 may apply different high accuracy settings for different target regions when performing the capacitance extractions. The area outside of the target regions in the layout can be identified as a peripheral region corresponding to a setting having relatively low accuracy but high efficiency for the capacitance extractions when compared to the high accuracy setting(s) applied in the target regions.

In some embodiments, when performing capacitance extractions, the design system 100 can combine different methods described above in FIG. 4-FIG. 8. For example, the design system 100 can apply the 3D capacitance determination process in some identified regions with different accuracy settings and apply the 2.5-D capacitance determination process in the remaining area in the layout. In some embodiments, the design system 100 can apply accuracy settings corresponding to one or more rectangular-shaped regions identified by the user, and also apply accuracy settings corresponding to the components or structures that correspond to one or more identified or selected signals. In some embodiments, the design system 100 can apply the 3D capacitance determination process with the accuracy settings corresponding to the components or structures that correspond to one or more identified or selected signals and apply the 2.5-D capacitance determination process to the remaining components or structures in the layout. These are examples of possible combinations of methods described in FIG. 4-FIG. 8, and do not limit the present disclosure.

After the capacitance extractions, the design system 100 can construct a netlist for the semiconductor layout based on the results of the capacitance extractions (e.g., a first capacitance extraction within a target region and a second capacitance extraction outside of the target region). Particularly, in some embodiments, the design system 100 can record multiple capacitance components (e.g., capacitance values C_{AB}, C_{BD}, C_{DE}, and C_{EF} in FIG. 6) and corresponding accuracy parameters associated with the capacitance components in the netlist. For example, capacitance value C_{AB} between structures A and B may be associated with a relevantly high resolution (e.g., accuracy with a tolerance of about 0.3%), while capacitance values C_{BD}, C_{DE}, and C_{EF} respectively between structures B and D, between structures D and E, and between structures E and F may be associated with a relevantly low resolution (e.g., accuracy with a tolerance of about 3%). In addition, in some embodiments, the design system 100 can further record coordinates which specify the X, Y, and/or Z boundaries identifying the high-resolution regions (e.g., regions 410, 610, and 710 respectively in FIG. 4, FIG. 6, and FIG. 7) in a header of the constructed netlist. For example, the coordinates recorded in the header may include the minimum X coordinate Xₘᵢₙ, the minimum Y coordinate Yₘᵢₙ, the maximum X coordinate Xₘₐₓ, and the maximum Y coordinate Yₘₐₓ, which are the coordinates defining X and Y boundaries of the high-resolution region.

Based on the constructed netlist, the design system 100 can perform the post-layout gate-level simulation and check whether the design meets the desired specification with the parasitic capacitances and resistances in the IC. The processes described above can be repeated until the design specification can be satisfied.

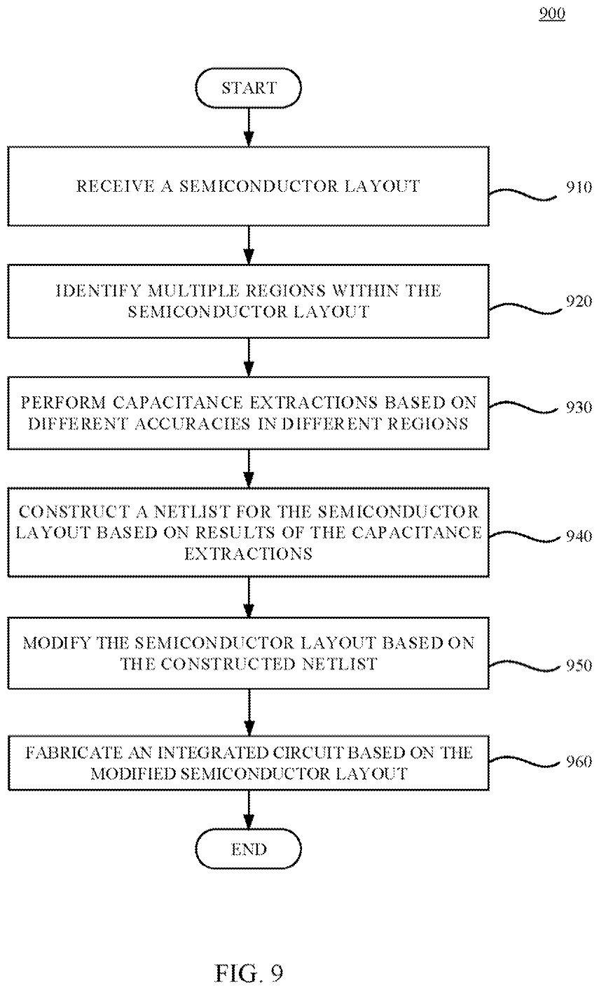

Reference is made to FIG. 9. FIG. 9 is a flow chart illustrating a method 900 for capacitance extraction in accordance with some embodiments of the present disclosure. For better understanding of the present disclosure, the method 900 is discussed in relation to the design system 100 shown in FIG. 1 and the embodiments shown in FIG. 2 to FIG. 8 but is not limited thereto. In some embodiments, the method 900 is described through various circuit simulation tools and/or electronic design automation (EDA) tools running on the design system 100 in FIG. 1. As shown in FIG. 9, in some embodiments, the method 900 includes operations 910, 920, 930, 940, 950, and 960.

At the operation 910, the design system 100 receives a semiconductor layout (e.g., the semiconductor layout 300 in FIG. 4). At the operation 920, the design system 100 identifies multiple regions (e.g., regions 410 and 420 in FIG. 4) within the semiconductor layout. In some embodiments, the regions are identified in response to a user's input. In some other embodiments, the regions can be determined, partially or completely, by the design system 100 automatically.

At the operation 930, the design system 100 performs capacitance extractions based on different accuracies in different regions by one or more capacitator extractors. For example, the one or more capacitator extractors can perform a first capacitance extraction on one or more first regions and a second capacitance extraction on one or more second regions, in which a resolution of the second capacitance extraction is less than a resolution of the first capacitance extraction.

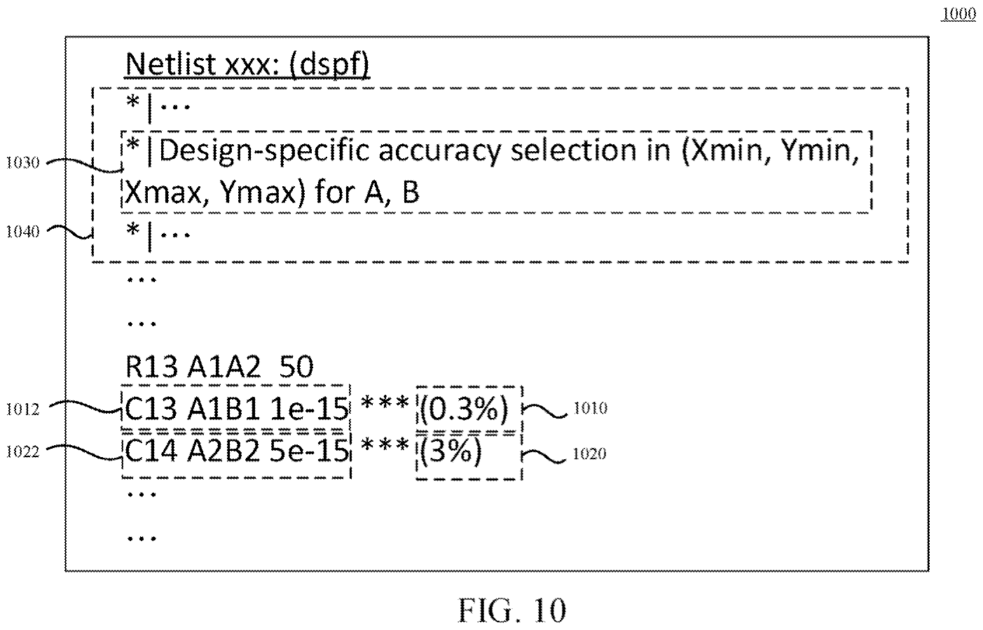

At the operation 940, the design system 100 constructs a netlist for the semiconductor layout based on results of the capacitance extractions. FIG. 10 is an exemplary netlist 1000 constructed after the capacitance extractions in accordance with some embodiments of the present disclosure. As shown in FIG. 10, the design system 100 can record corresponding accuracy parameters (e.g., in areas 1010, 1020 in FIG. 10) associated with capacitance components (e.g., in areas 1012, 1022 in FIG. 10) in the netlist 1000. The design system 100 can also record coordinates (e.g., in an area 1030 in FIG. 10) identifying the regions with a high resolution or a low resolution in a header section 1040 of the netlist 1000. The netlist 1000 illustrated in FIG. 10 is a simplified example to help understand of the present disclosure, and not meant to limit the present disclosure.

At the operation 950, the design system 100 modifies the semiconductor layout based on the constructed netlist (e.g., netlist 1000 in FIG. 10). In some embodiments, the design system 100 can repeat operations 910-950, and perform a verification process. As explained above in connection with FIG. 2, the design system 100 may perform a post-layout gate-level simulation to ensure that the modified semiconductor layout design meets the specification with the parasitic capacitances and resistances in the IC, until the simulation results satisfy the design specification and the optimized semiconductor layout for IC fabrication is obtained.

At the operation 960, after the design layout is finalized, an integrated circuit can be fabricated based on the modified semiconductor layout. For example, in the IC fabrication process, electron-beam (e-beam) lithography can be used for transferring an IC pattern including features of the semiconductor layout to an e-beam sensitive resist layer coated on a semiconductor substrate. In some embodiments, a tape-out of the modified IC pattern for mask making or e-beam writing can be generated. The tape-out represents an IC pattern in a format that can be used for mask making or e-beam writing. The tape-out can be formed based on the modified semiconductor layout generated at the operation 950.

In some embodiments, the IC fabrication process can proceed to an operation for the fabrication of a mask or a set of masks based on the tape-out. The mask(s) are used in a photolithography process to transfer the features to the semiconductor substrate. For example, an e-beam or a mechanism of multiple e-beams can be used to form a pattern on a mask (photomask or reticle) based on the modified semiconductor layout. The mask can be formed using various suitable technologies. For example, the mask may be a transmissive mask or a reflective mask, such as an extreme ultraviolet mask (EUV) mask, but the present disclosure is not limited thereto.

The above illustrations include exemplary operations, but the operations are not necessarily performed in the order shown. Operations may be added, replaced, changed order, and/or eliminated as appropriate, without departing from the spirit and scope of the present disclosure.

By applying different extraction accuracies in different regions in the layout to conduct capacitance extractions, the EDA tools running on the design system can achieve a desired balance between the accuracy, the processing time, and the computing resources required for capacitance extractions, which improves the capacity and performance, while the EDA tools handle complicated designs, such as IC layouts having 101-stages ring oscillator, SRAM bit cell array, etc.

In some embodiments, a method for capacitance extraction is disclosed that includes performing a first capacitance extraction on one or more first regions of a semiconductor layout; performing a second capacitance extraction on one or more second regions of the semiconductor layout, a resolution of the second capacitance extraction being less than a resolution of the first capacitance extraction; constructing a netlist for the semiconductor layout based on results of the first capacitance extraction and of the second capacitance extraction; and modifying the semiconductor layout based on the netlist, the modified semiconductor layout being used to fabricate an integrated circuit.

In some embodiments, a system is also disclosed that includes a processing unit and one or more memory units storing instructions for one or more programs executable by the processing unit to perform operations. The operations include: receiving a semiconductor layout; identifying a plurality of regions within the semiconductor layout; performing capacitance extractions based on different accuracies on the plurality of regions; constructing a netlist for the semiconductor layout based on results of the capacitance extractions; and modifying the semiconductor layout based on the netlist, the modified semiconductor layout being used to fabricate an integrated circuit.

In some embodiments, a non-transitory computer-readable storage medium is also disclosed. The non-transitory computer-readable storage medium stores a set of instructions that are executable by one or more processors of a device to cause the device to perform a method. The method includes: performing a first capacitance extraction having a first accuracy on one or more first regions of a semiconductor layout; performing a second capacitance extraction having a second accuracy being different from the first accuracy on one or more second regions outside of the one or more first regions; constructing a netlist for the semiconductor layout based on results of the first capacitance extraction and of the second capacitance extraction; and modifying the semiconductor layout based on the netlist, the modified semiconductor layout being used to fabricate an integrated circuit.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for capacitance extraction, comprising:
performing a first capacitance extraction on one or more first regions of a semiconductor layout;
performing a second capacitance extraction on one or more second regions of the semiconductor layout, a resolution of the second capacitance extraction being less than a resolution of the first capacitance extraction;
constructing a netlist for the semiconductor layout based on results of the first capacitance extraction and of the second capacitance extraction; and
modifying the semiconductor layout based on the netlist, the modified semiconductor layout being used to fabricate an integrated circuit.

2. The method of claim 1, wherein the performing the first capacitance extraction comprises:
applying a three-dimensional (3D) capacitance determination process based on a first step size parameter to generate a first netlist comprising one or more capacitance results associated with the one or more first regions.

3. The method of claim 2, wherein performing the second capacitance extraction comprises:
applying the 3D capacitance determination process based on a second step size parameter being greater than the first step size parameter to generate a second netlist comprising one or more capacitance results associated with the one or more second regions.

4. The method of claim 1, wherein performing the second capacitance extraction comprises:
applying a 2.5-dimensional (2.5-D) capacitance determination process to generate a second netlist comprising one or more capacitance results associated with the one or more second regions.

5. The method of claim 1, further comprising:
identifying an area comprising a functional circuit in the semiconductor layout as the one or more first regions.

6. The method of claim 1, further comprising:
determining one or more step size parameters for the first capacitance extraction or the second capacitance extraction by an artificial intelligence or machine learning model.

7. The method of claim 1, further comprising:
calculating, based on a first step size parameter, a first capacitance parameter associated with a first portion of a first structure and a first portion of a second structure, the first portion of the first structure and the first portion of the second structure being within the one or more first regions; and
calculating, based on a second step size parameter being different from the first step size parameter, a second capacitance parameter associated with a second portion of the first structure and a second portion of the second structure, the second portion of the first structure and the second portion of the second structure being within the one or more second regions.

8. The method of claim 7, further comprising:
calculating, based on the second step size parameter, a third capacitance parameter associated with the first portion of the first structure and the second portion of the second structure;
calculating, based on the second step size parameter, a fourth capacitance parameter associated with the second portion of the first structure and the first portion of the second structure; and
calculating a capacitance value associated with the first structure and the second structure based on the first capacitance parameter, the second capacitance parameter, the third capacitance parameter, and the fourth capacitance parameter.

9. The method of claim 1, further comprising:
recording corresponding accuracy parameters associated with a plurality of capacitance components in the semiconductor layout in the netlist.

10. The method of claim 1, further comprising:
recording coordinates identifying the one or more first regions in a header of the netlist.

11. The method of claim 1, further comprising:
determining an accuracy configuration associated with a signal of the semiconductor layout; and
applying a capacitance determination process based on the accuracy configuration to calculate a capacitance value between at least two components associated with the signal.

12. A system, comprising:
a processing unit; and
one or more memory units storing instructions for one or more programs executable by the processing unit to perform operations comprising:
receiving a semiconductor layout;
identifying a plurality of regions within the semiconductor layout;
performing capacitance extractions based on different accuracies on the plurality of regions;
constructing a netlist for the semiconductor layout based on results of the capacitance extractions; and
modifying the semiconductor layout based on the netlist, the modified semiconductor layout being used to fabricate an integrated circuit.

13. The system of claim 12, wherein the operations further include:
applying a three-dimensional capacitance determination process based on a first step size parameter to calculate a capacitance value between at least two components within one or more first regions of the plurality of regions.

14. The system of claim 13, wherein the operations further include:
applying the three-dimensional capacitance determination process based on a second step size parameter being greater than the first step size parameter to calculate a capacitance value between at least two components within one or more second regions different from the one or more first regions.

15. The system of claim 13, wherein the operations further include:
applying a 2.5-dimensional capacitance determination process to calculate a capacitance value between at least two components within one or more second regions different from the one or more first regions.

16. The system of claim 12, wherein the operations further include:
determining an accuracy configuration associated with a signal; and
applying a capacitance determination process based on the accuracy configuration to calculate a capacitance value between at least two components associated with the signal.

17. A non-transitory computer-readable storage medium storing a set of instructions that are executable by one or more processors of a device to cause the device to perform a method, the method comprising:
performing a first capacitance extraction having a first accuracy on one or more first regions of a semiconductor layout;
performing a second capacitance extraction having a second accuracy being different from the first accuracy on one or more second regions outside of the one or more first regions;
constructing a netlist for the semiconductor layout based on results of the first capacitance extraction and of the second capacitance extraction; and
modifying the semiconductor layout based on the netlist, the modified semiconductor layout being used to fabricate an integrated circuit.

18. The non-transitory computer-readable storage medium of claim 17, wherein the performing the first capacitance extraction comprises:
applying a three-dimensional capacitance determination process based on a first step size parameter to calculate a capacitance value between at least two components within the one or more first regions.

19. The non-transitory computer-readable storage medium of claim 17, wherein the performing the second capacitance extraction comprises:
applying a 2.5-dimensional capacitance determination process to calculate a capacitance value between at least two components within the one or more second regions.

20. The non-transitory computer-readable storage medium of claim 17, wherein the method further comprises:
determining an accuracy configuration associated with a signal; and
applying a capacitance determination process based on the accuracy configuration to calculate a capacitance value between at least two components associated with the signal.
